(19) United States
(12) Patent Application Publication
(10) Pub. No.: US 2024/0110430 A1
(43) Pub. Date: Apr. 4, 2024

(54) ASSISTANCE DEVICE

(71) Applicant: TOYOTA JIDOSHA KABUSHIKI KAISHA, Toyota-shi (JP)

(72) Inventors: Hiroaki SUTO, Toyota-shi (JP); Takeru YOSHIDA, Toyota-shi (JP); Akihiro UMENAGA, Toyota-shi (JP)

(21) Appl. No.: 18/458,219

(22) Filed: Aug. 30, 2023

(30) Foreign Application Priority Data
Sep. 29, 2022 (JP) 2022-156776

(51) Int. Cl. E05F 15/70

(52) U.S. Cl. CPC E05F 15/70; E05Y 2900/55

(57) ABSTRACT

An assistance device installed at a vehicle. The assistance device includes: a memory; and a processor coupled to the memory. The processor being configured to: receive information relating to a window opening point corresponding to a predetermined service, notify the service of proximity in a case in which the vehicle has reached a predetermined range from the window opening point, and open a window of the vehicle in a case in which the vehicle has approached the window opening point.

### CROSS-REFERENCE TO RELATED APPLICATION

This application is based on and claims priority under 35 USC 119 from Japanese Patent Application No. 2022-156776 filed on Sep. 29, 2022, the disclosure of which is incorporated by reference herein.

### BACKGROUND

### Technical Field

The present disclosure relates to an assistance device.

### Related Art

Japanese Patent Application Laid-Open (JP-A) No. 2002-114054 discloses a control device that opens a windowpane by transmitting a control signal in order to open the windowpane when drowsiness of a driver is detected.

JP-A No. 2002-114054 discloses control of opening and closing in response to a state of a driver inside a vehicle, and does not consider cooperation with external services.

### SUMMARY

An aspect of the present disclosure is an assistance device installed at a vehicle, the assistance device comprising: a memory; and a processor coupled to the memory, the processor being configured to: receive information relating to a window opening point corresponding to a predetermined service, notify the service of proximity in a case in which the vehicle has reached a predetermined range from the window opening point, and open a window of the vehicle in a case in which the vehicle has approached the window opening point.

The assistance device of the first aspect detects proximity of a vehicle to a window opening point corresponding to a service, notifies the service, and performs control of a vehicle window. This enables the window to be controlled in cooperation with the service.

A second aspect of the present disclosure is the assistance device of the first aspect, wherein the processor automatically opens the window after having notified a user with a window opening alert, in a case in which the vehicle has approached the window opening point. The assistance device of the second aspect enables the user to be informed in advance of the opening of the window.

A third aspect of the present disclosure is the assistance device of the first aspect, wherein the processor: acquires vehicle information including a vehicle speed of the vehicle, calculates a timing of arrival at the window opening point from a travel situation based on the vehicle information, and notifies the service of proximity and automatically opens the window in accordance with the timing. The assistance device of the third aspect enables the window to be opened at an appropriate timing in consideration of a travel situation of the vehicle.

A fourth aspect of the present disclosure is the assistance device of the third aspect, wherein the processor, after notifying the service of proximity, requests permission to open the window from the user. The assistance device of the fourth aspect is able to check with the user as to whether or not to perform assistance.

A fifth aspect of the present disclosure is the assistance device of the first aspect, wherein the processor: detects an external environment of the vehicle, and in a case in which the external environment is not favorable for opening the window, notifies the user, and requests permission to open the window. The assistance device of the fifth aspect is able to check with the user as to whether or not to perform assistance in cases of inclement weather or the like.

Further, the assistance device of any one of the first to fifth aspects may be configured to have a display at which the service point can be displayed on a map, to display the service point on a map, to receive information relating to the window opening point by allowing the user to select the service, and to display information relating to the window opening point on the map. This enables the user to select a service on a map.

The present disclosure enables control of a window in cooperation with a service.

### BRIEF DESCRIPTION OF THE DRAWINGS

FIG. 1 is a diagram illustrating a configuration of an assistance system.

FIG. 2 is a block diagram illustrating a hardware configuration of an ECU.

FIG. 3 is a block diagram illustrating an example of functional configuration of an ECU.

FIG. 4 is a flowchart illustrating a flow of assistance processing serving as an assistance method executed by the ECU of the present exemplary embodiment.

### DETAILED DESCRIPTION

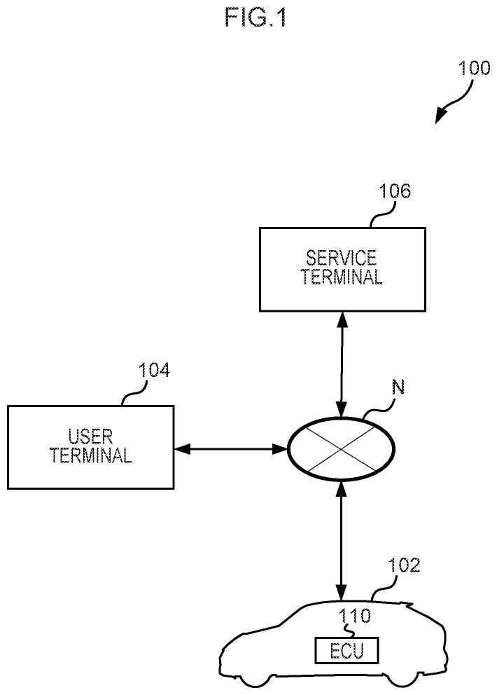

FIG. 1 is a diagram illustrating a configuration of an assistance system 10. As illustrated in FIG. 1, the assistance system 10 includes a vehicle 102, a user terminal 104, and a service terminal 106, which are connected together through a network N. Note that a case in which there is one of each of the vehicle 102, user terminal 104, and service terminal 106 is illustrated. The illustration as such is for simplicity of explanation. The assistance system 10 includes plural vehicles 102, plural user terminals 104, and plural service terminals 106 managed by the assistance system 10 as control targets.

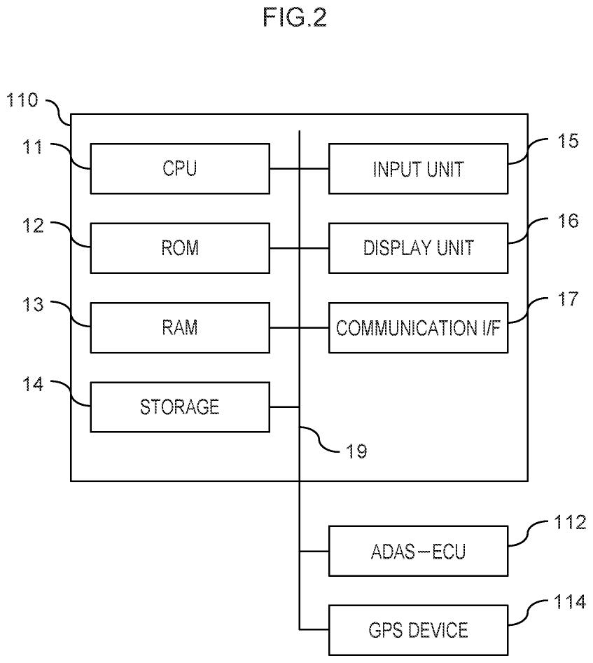

The vehicle 102 includes an electronic control unit (ECU) 110 and a window opening/closing mechanism. The ECU 110 acquires vehicle information relating to the vehicle 10 and performs control. The opening/closing mechanism of the window can be automatically opened and closed by the ECU 110. In the present exemplary embodiment, the ECU 110 performs control relating to window opening assistance in cooperation with a service (hereafter, simply referred to as window opening assistance). The ECU 110 is connected to an Advanced Driver Assistance System (ADAS)-ECU 112 and a GPS device 114, as described below with reference to FIG. 2. The ADAS-ECU 112 is a mechanism that comprehensively controls an advanced driving assistance system, and is provided with sensors that detect vehicle information such as vehicle speed, yaw rate, and driving operations, and the external environment by camera, radar, or the like. The ECU 110 acquires various required vehicle information from the ADAS-ECU 112 and the GPS device 114, and has a function that performs control relating to window opening assistance in response to proximity to a window opening point. Regarding control relating to window opening assistance, explanation follows regarding the functional configuration of control relating to window opening assistance of the ECU 110, which is described below. The ECU 110 is an example of an assistance device of the present disclosure.

Moreover, a GPS device 114 installed in the vehicle 102 is connected to the ECU 110. The GPS device 114 is a device that measures a current position of the vehicle 102. The GPS device 114 includes an antenna that receives signals from GPS satellites. The ECU 110 controls a car navigation system, audio, and the like. The car navigation system manages position information on a map of a predetermined service, which is described below. The ECU 110 performs control relating to window opening assistance using the position information of the vehicle 102 measured by the GPS device 114 and position information on the map.

The user terminal 104 is a terminal installed with an application relating to window opening assistance. Note that an onboard device installed in the vehicle 102 may be used as the user terminal 104.

The service terminal 106 is a terminal installed in a store, a facility, or the like that provides a predetermined service. The predetermined service is, for example, any of a number of services corresponding to transfer of goods through a window by means of drive-through provided at a store, a facility, or the like. Note that the service terminal 106 is provided with an application or functionality for accepting notification of window opening assistance.

FIG. 2 is a block diagram illustrating a hardware configuration of the ECU 110. As illustrated in FIG. 2, the ECU 110 includes a central processing unit (CPU) 11, read only memory (ROM) 12, random access memory (RAM) 13, storage 14, an input unit 15, a display unit 16, and a communication interface (I/F) 17. The respective component elements are connected together through a bus 19 so as to be capable of communicating with each other. Note that the user terminal 104 and the service terminal 106 may have similar hardware configuration to the ECU 110.

The CPU 11 is an example of a hardware processor, and executes various programs and controls various units. Namely, the CPU 11 loads a program from the ROM 12 or the storage 14, and executes the program using the RAM 13 as a workspace. The CPU 11 controls the respective configurations and performs various computation processing according to a program stored in the ROM 12 or the storage 14. In the present exemplary embodiment, an information processing program is stored in the ROM 12 or the storage 14.

The ROM 12 holds various programs and various data. The RAM 13 serves as a workspace to temporarily store programs and data. The storage 14 may be a storage device such as a hard disk drive (HDD), a solid state drive (SSD), or flash memory, and holds various programs including an operating system, as well as various data. The ROM 12, the RAM 13, and the storage 14 correspond to a memory.

The input unit 15 includes a touch panel type keyboard and buttons or the like, and is used to perform various inputs.

The display unit 16 is, for example, a liquid crystal display, and displays various information. The display unit 16 may employ a touch panel format to function as the input unit 15.

The communication interface 17 is an interface for communicating with other devices, and may be, for example, an interface of a protocol such as Ethernet (registered trademark), FDDI, Wi-Fi (registered trademark), BLE, NFC, or UWB.

When the computer program described above is executed, the ECU 110 implements various functionalities using the hardware resources described above. Explanation follows regarding functional configuration implemented by the ECU 110. Note that applications relating to window opening assistance are installed on the user terminal 104 or onboard equipment, and input from a user is received through the input unit 15.

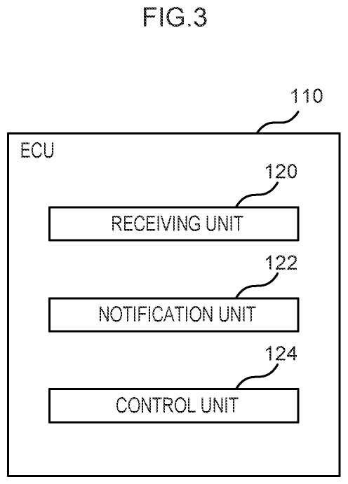

FIG. 3 is a block diagram illustrating an example of functional configuration of the ECU 110. As illustrated in FIG. 3, the ECU 110 includes a receiving unit 120, a notification unit 122, and a control unit 124 as functional configuration. The respective functional configuration is implemented by the CPU 11 loading and executing a computer program stored in the ROM 12 or the storage 14.

The receiving unit 120 receives information relating to a window opening point corresponding to a predetermined service. The information relating to the window opening point is position information of the service provision point, the type of the service, and the like. The information relating to the window opening point may be received by, for example, an input to an application relating to window opening assistance from a user onboard the vehicle 102.

The notification unit 122 determines whether or not the vehicle 102 has reached a predetermined range from the window opening point corresponding to the service, and in a case in which the predetermined range has been reached, the service terminal 106 corresponding to the service concerned is notified of the approach. The predetermined range can be appropriately determined, for example, by setting a range of a point predicted to be several minutes until reaching the window opening point as the predetermined range. Moreover, in cases in which the provision preparation time for a product is different for each store or facility, a predetermined range may be determined according to the provision preparation time for each store or facility.

The control unit 124 determines whether or not the vehicle 102 has approached the window opening point, and performs control so as to automatically open the window when the vehicle has approached the window opening point. Approach to the window opening point may be determined to be within an appropriate range of proximity; for example, in a case in which the vehicle 102 reaches a point that is several meters to several tens of meters from the window opening point.

Moreover, in a case in which the control unit 124 determines that the vehicle 102 has approached the window opening point, the notification unit 122 notifies the user with a window opening alert. The control unit 124 performs control to automatically open the window after the notification unit 122 notifies the user with a window opening alert. The notification to the user may be performed by audio notification via a speaker managed by the ECU 110 or by communication with the user terminal 104.

Flow of Control

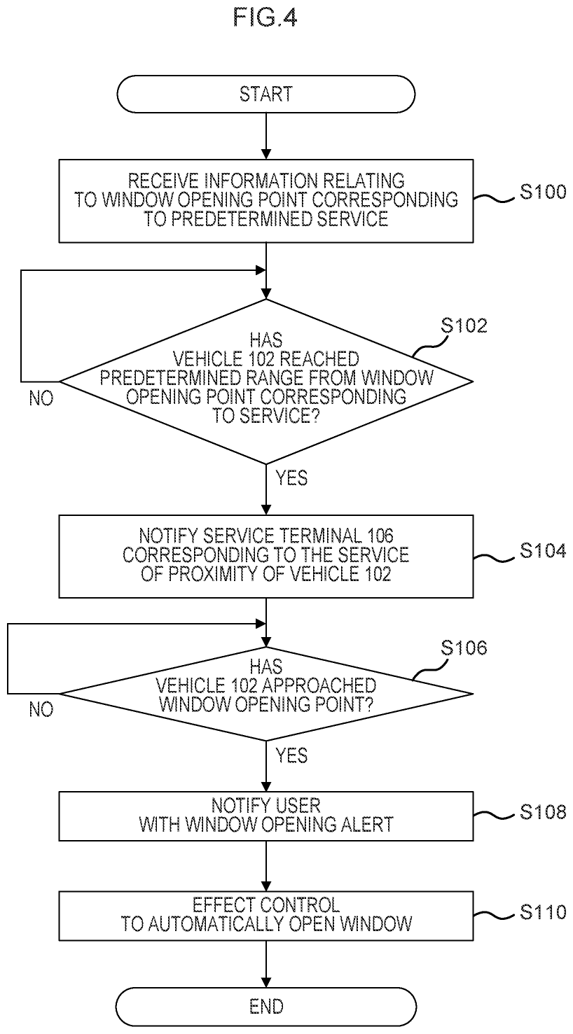

FIG. 4 is a flowchart illustrating a flow of assistance processing serving as an assistance method executed by the ECU 110 of the present exemplary embodiment.

At step S100, the CPU 11 receives information relating to a window opening point corresponding to a predetermined service.

At step S102, the CPU 11 determines whether or not the vehicle 102 has reached a predetermined range from the window opening point corresponding to the service. In a case in which it is determined that the predetermined range has been reached, the processing transitions to step S104, and in a case in which it is determined that the predetermined range has not been reached, step S102 is repeated.

At step S104, the CPU 11 notifies the service terminal 106 corresponding to the service of the proximity of the vehicle 102.

At step S106, the CPU 11 determines whether or not the vehicle 102 has approached the window opening point. In a case in which it is determined that it has approached, the processing transitions to step S108, and in a case in which it is determined that it has not approached, step S106 is repeated.

At step S108, the CPU 11 notifies the user with a window opening alert.

At step S110, the CPU 11 performs control to automatically open the window.

As described above, the assistance system 100 of the present exemplary embodiment enables control of windows in cooperation with services.

### Modified Example

The ECU 110 may use the receiving unit 120 to acquire vehicle information, including the vehicle speed, from the ADAS-ECU 112, and the timing at which the vehicle reaches the window opening point may be calculated from the travel situation based on the vehicle information. The travel situation is traffic information such as average vehicle speed, busyness of a road during travel, or congestion. The timing is the arrival time at the window opening point predicted from the travel situation. The notification unit 122 performs notification according to the timing. The control unit 124 performs window opening control according to the timing. For example, the notification according to the timing may be performed at a predicted time of several minutes to the arrival of the window opening point, calculated backward from the timing. For example, the control according to the timing may be performed at a predicted time of several seconds to several tens of seconds until the window opening point is reached, calculated backward from the timing. Note that this notification and control are examples, and notification and control according to the timing may be determined as appropriate.

Alternatively, the ECU 110 may request the user for permission to control after notifying the user with a window opening alert. The permission to control may be configured, for example, such that a selection button for permission to control is displayed on the display unit 16 so as to enable a user to select permission to control by operation of the input unit 15. The ECU 110 may effect control so as to display and select whether or not similar control is possible using an application relating to window opening assistance of the user terminal 104.

Moreover, the control unit 124 of the ECU 110 detects the external environment of the vehicle, and in cases in which the external environment is not favorable for opening the window, the user may be notified and permission for control requested. The ECU 110 uses the ADAS-ECU 112 to acquire information from a camera, a radar, and the like, and detects the external environment. A case in which the external environment is not favorable for opening the window, is presumed a case of inclement weather, for example, such as rain, snow, or strong winds.

Further, the service point may be displayable on a map at the display unit 16 of the vehicle 102. The ECU 110 displays the service points on a map displayed at the display unit 16, and information relating to the window opening point is received by using the input unit 15 to select a service. The ECU 110 displays information relating to a window opening point on the map. In this case, as information relating to the window opening point, a display color, icon format, or the like, of information relating to the window opening point may be displayed on the map so as to be distinguishable from a service that is not a window opening point. Moreover, in cases in which the ECU 110 reaches the predetermined range or approaches a window opening point as described above, the display of information relating to the window opening point on the map may be changed. For example, the display color of the information may be changed, the size may be changed, the flashing speed may be changed, or suchlike.

Note that the various processing executed by the CPU 11 loading and executing software (a program) in the above-described exemplary embodiments may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). Alternatively, a processor suitable for graphic processing and matrix computation, such as a graphics processing unit (GPU), may be used. The respective processing described above may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

In the above-described exemplary embodiments, the information processing program is stored (installed) in advance in a non-transitory recording medium readable by a computer. For example, the information processing program is stored in advance in the ROM 12 or the storage 14. However, the respective programs are not limited thereto, and may be provided in a format recorded on a non-transitory recording medium such as compact disc read only memory (CD-ROM), digital versatile disc read only memory (DVD-ROM), or universal serial bus (USB) memory. Alternatively, the information processing program may be provided in a format downloadable from an external device over a network.

The flow of processing described in the foregoing exemplary embodiments is an example, and unnecessary steps may be deleted, new steps may be added, or the processing order may be rearranged within a range not departing from the spirit of the present invention.

An object of the present disclosure is to provide an assistance device that enables control of a window in cooperation with a service.

A first aspect of the present disclosure is an assistance device installed at a vehicle, the assistance device comprising: a memory; and a processor coupled to the memory, the processor being configured to: receive information relating to a window opening point corresponding to a predetermined service, notify the service of proximity in a case in which the vehicle has reached a predetermined range from the window opening point, and open a window of the vehicle in a case in which the vehicle has approached the window opening point.

The assistance device of the first aspect detects proximity of a vehicle to a window opening point corresponding to a service, notifies the service, and performs control of a vehicle window. This enables the window to be controlled in cooperation with the service.

A second aspect of the present disclosure is the assistance device of the first aspect, wherein the processor automatically opens the window after having notified a user with a window opening alert, in a case in which the vehicle has approached the window opening point. The assistance device of the second aspect enables the user to be informed in advance of the opening of the window.

A third aspect of the present disclosure is the assistance device of the first aspect, wherein the processor: acquires vehicle information including a vehicle speed of the vehicle, calculates a timing of arrival at the window opening point from a travel situation based on the vehicle information, and notifies the service of proximity and automatically opens the window in accordance with the timing. The assistance device of the third aspect enables the window to be opened at an appropriate timing in consideration of a travel situation of the vehicle.

A fourth aspect of the present disclosure is the assistance device of the third aspect, wherein the processor, after notifying the service of proximity, requests permission to open the window from the user. The assistance device of the fourth aspect is able to check with the user as to whether or not to perform assistance.

A fifth aspect of the present disclosure is the assistance device of the first aspect, wherein the processor: detects an external environment of the vehicle, and in a case in which the external environment is not favorable for opening the window, notifies the user, and requests permission to open the window. The assistance device of the fifth aspect is able to check with the user as to whether or not to perform assistance in cases of inclement weather or the like.

Further, the assistance device of any one of the first to fifth aspects may be configured to have a display at which the service point can be displayed on a map, to display the service point on a map, to receive information relating to the window opening point by allowing the user to select the service, and to display information relating to the window opening point on the map. This enables the user to select a service on a map.

The present disclosure enables control of a window in cooperation with a service.

What is claimed is:

1. An assistance device installed at a vehicle, the assistance device comprising:
a memory; and
a processor coupled to the memory, the processor being configured to:
receive information relating to a window opening point corresponding to a predetermined service,
notify the service of proximity in a case in which the vehicle has reached a predetermined range from the window opening point, and
open a window of the vehicle in a case in which the vehicle has approached the window opening point.

2. The assistance device of claim 1, wherein the processor automatically opens the window after having notified a user with a window opening alert, in a case in which the vehicle has approached the window opening point.

3. The assistance device of claim 1, wherein the processor:
acquires vehicle information including a vehicle speed of the vehicle,
calculates a timing of arrival at the window opening point from a travel situation based on the vehicle information, and
notifies the service of proximity and automatically opens the window in accordance with the timing.

4. The assistance device of claim 3, wherein the processor, after notifying the service of proximity, requests permission to open the window from the user.

5. The assistance device of claim 1, wherein the processor:
detects an external environment of the vehicle, and
in a case in which the external environment is not favorable for opening the window, notifies the user, and requests permission to open the window.
